(19) United States
(12) Patent Application Publication
(10) Pub. No.: US 2017/0242191 A1
(43) Pub. Date: Aug. 24, 2017

(54) PHOTONICALLY INTEGRATED CHIP, OPTICAL COMPONENT HAVING A PHOTONICALLY INTEGRATED CHIP, AND METHOD FOR THE PRODUCTION THEREOF

(71) Applicants: Technische Universität Berlin, Berlin (DE); Sicoya GmbH, Berlin (DE)

(72) Inventors: Hanjo RHEE, Berlin (DE); Marvin HENNIGES, Berlin (DE); Stefan MERSTER, Berlin (DE); Christoph THEISS, Berlin (DE); David SELICKE, Altlandsberg (DE); David STOLAREK, Frankfurt (Oder) (DE); Lars ZIMMERMANN, Berlin (DE); Harald H. RICHTER, Frankfurt (Oder) (DE)

(73) Assignees: Technische Universität Berlin, Berlin (DE); Sicoya GmbH, Berlin (DE)

(21) Appl. No.: 15/515,486

(22) PCT Filed: Sep. 25, 2015
(86) PCT No.: PCT/DE2015/200463

§ 371 Date: Mar. 29, 2017

(30) Foreign Application Priority Data
Sep. 29, 2014 (DE) 10 2014 219 663.9

(51) Int. Cl. G02B 6/124; G02B 6/136; G02B 6/42

(52) U.S. Cl. CPC G02B 6/124; G02B 6/4206; G02B 6/136; G02B 2006/12097

(57) ABSTRACT

The invention relates, inter alia, to a photonically integrated chip (2) having a substrate (20), a plurality of material layers arranged on a top side (21) of the substrate (20), an optical waveguide which is integrated in one or more wave-guiding material layers of the chip (2), and a grating coupler (60) which is formed in the optical waveguide and causes beam deflection of radiation guided in the waveguide in the direction out of the layer plane of the wave-guiding material layer(s) or causes beam deflection of radiation to be coupled into the waveguide in the direction into the layer plane of the wave-guiding material layer(s).

With respect to the chip, the invention provides for an optical diffraction and refraction structure (100, 100a) to be integrated in a material layer of the chip (2) above or below the optical grating coupler (60) or in a plurality of material layers above or below the optical grating coupler (60) or on the rear side of the substrate (20), which diffraction and refraction structure carries out beam shaping of the radiation before it is coupled into the waveguide or after it has been coupled out of the waveguide.

The invention relates to photonically integrated chips, to optical elements having such chips and to methods for producing them. The term “photonically integrated chips” is understood as meaning integrated chips which have a substrate and material layers situated on said substrate (for example grown on or deposited) and in which one or more photonic components (for example waveguides, couplers, etc.) are integrated in one or more of the material layers.

When developing optical components, in particular integrated optical components, the problem often arises of light having to be transmitted from one component to another, for example from a laser to a waveguide on a chip or from the chip to a fiber. In this case, it is fundamentally possible, on the one hand, to place the two components beside one another and to couple the light horizontally in the plane of the waveguide, also called butt coupling. On the other hand, the components can be placed on top of one another in order to transmit the light vertically or virtually vertically with respect to the plane of the waveguide. In the latter variant, the light striking the waveguide at a small angle with respect to the surface normal is generally deflected into the waveguide via a grating coupler and is guided further in the waveguide.

When very divergent or convergent radiation is vertically coupled in a waveguide, the current methods entail great losses because the grating couplers which are usually used have only a limited angular acceptance. These other optical components likewise have an angular acceptance when coupling light out of a waveguide into other optical components, for example fibers (for example glass or polymer fibers). The portions of the radiation which are incident outside the angular acceptance are not coupled into the waveguide or the fiber, for example, and are lost. These losses are greater, the more divergent or convergent the incident light. On account of the beam divergence, the coupling losses may increase with greater distance between the coupling elements if the aperture of the target coupling element does not suffice. The upper material layers of optical elements, also called “backend of line” of the element in technical terminology, having five metal layers, for example, have a thickness of approximately 20 μm. During the propagation of a divergent light beam over this distance, its beam diameter increases significantly.

In the case of a very divergent or convergent light source, nowadays a fiber is usually interposed between the light source and the grating coupler of the waveguide. The light is first of all coupled into the fiber and is coupled out of the fiber at the other fiber end and is coupled into the waveguide via the grating coupler. This is associated with great manufacturing effort, additional components and coupling losses at the entrance and exit facets of the fiber [1].

Another approach is to use micro-optics, for example lenses, as separate components which are fastened on the element (also called “chip” for short below in technical terminology in the case of integrated elements) above the grating coupler and are intended to collimate or focus the vertically incident light. This method also requires a large amount of manufacturing effort with additional components (for example injection molding or glass micro-lenses), manufacturing steps and associated tolerances and poor scalability [2].

Another approach is to use lenses which are etched into the exit facet of a laser in order to collimate or focus the emitted light before it emerges from the laser [3].

A photonically integrated chip having the features according to the precharacterizing clause of patent claim 1 is known from the publication “A polarization-diversity wavelength duplexer circuit in silicon-on-insulator photonic wires” (Wim Bogaerts, Dirk Taillaert, Pieter Dumon, Dries Van Thourhout, Roel Baets; Feb. 19, 2007/Vol. 15, no. 4/OPTICS EXPRESS 1567).

Proceeding from the last-mentioned prior art, the invention is based on the object of easily improving the coupling efficiency which can be achieved in the chip.

This object is achieved, according to the invention, by means of a photonically integrated chip having the features according to patent claim 1. Advantageous configurations of the chip according to the invention are stated in subclaims.

According to this, the invention provides for an optical diffraction and refraction structure to be integrated in a material layer of the chip above or below the optical grating coupler or in a plurality of material layers above or below the optical grating coupler or on the rear side of the substrate, which diffraction and refraction structure carries out beam shaping of the radiation before it is coupled into the waveguide or after it has been coupled out of the waveguide.

As a result of the diffraction and refraction structure provided according to the invention, the wave front of the incident light can be transformed into any desired wave front of the emerging light. The invention makes it possible, for example, to collimate and focus the incident light if the diffraction and refraction structure is implemented according to the principle of a discretized lens or Fresnel lens. This makes it possible, for example, to reduce the beam divergence of the incident light to such an extent that the entire beam propagates within the acceptance angle of the grating coupler and can be coupled into the waveguide only with very low losses. In addition, the diffraction and refraction structure also means that the diameter of the incident light is adapted to the aperture of the grating coupler, thus minimizing losses caused by beam parts which do not strike the grating coupler. In this case, the incident light may come, for example, both from a fiber (for example glass or polymer fiber), a further photonically integrated chip, and directly from a laser (for example HCSEL, VCSEL). Furthermore, it is possible to couple light out of upper material layers of the chip (the so-called “backend of line”) into a second optical component, for example a fiber, a further photonically integrated chip, a photodetector or micro-optics, via the diffraction and refraction structure. For this purpose, the diffraction and refraction structure may be adapted in such a manner that beam divergence of the emergent light for the most efficient possible coupling into the target component is achieved.

Another great advantage is the extremely low manufacturing tolerance and therefore alignment accuracy of the diffraction and refraction structure with respect to the grating coupler in comparison with conventional methods with separate components. The reason is that the diffraction and refraction structure is produced, for example, using lithographic production methods with a very high degree of precision and positioning accuracy as a result of lithographic alignment methods instead of mechanical positioning and adhesive bonding of individual components. A silicon-on-insulator (SOI) substrate can be used, for example, as the material system for producing photonically integrated chips.

In the chip according to the invention, there is advantageously no need for any separate components with associated packaging effort. In addition, the components to be coupled can be placed closer together, thus making it possible to reduce scattering losses and apertures of the coupling structures. The integrated production enables considerably better scalability, for example when producing a plurality of couplers on a photonically integrated chip. In this case, there is no repeated effort needed to position and adhesively bond additional individual components.

It is considered to be particularly advantageous if the optical diffraction and refraction structure forms a lens, a beam splitter or a polarization separator.

The optical diffraction and refraction structure is preferably formed by steps in one or more material layers of the chip above or below the optical grating coupler or at least also comprises such steps.

The waveguide is preferably a ridge waveguide which comprises a ridge formed in a wave-guiding material layer of the chip. In such a configuration, the optical diffraction and refraction structure is preferably integrated in one or more layers of the chip above or below the ridge.

The substrate of the chip is preferably a semiconductor material, for example silicon.

The chip is particularly preferably based on SOI (silicon on insulator) material. In the case of such a material system, it is considered to be advantageous if the ridge waveguide is formed in a silicon covering layer of an SOI material, and the optical diffraction and refraction structure is integrated in one or more layers of the chip above the silicon covering layer.

The grating coupler may be a one-dimensional or two-dimensional grating coupler. The grating coupler is preferably a Bragg grating or preferably also at least comprises such a Bragg grating.

The diffraction and refraction structure is preferably two-dimensional and is preferably in a plane parallel to the wave-guiding material layer(s).

With regard to an optimum coupling efficiency, it is considered to be particularly advantageous if the diffraction and refraction structure is location-dependent in two dimensions, specifically in a dimension dependent on the location along the longitudinal direction of the waveguide and in a dimension perpendicular thereto dependent on the location perpendicular to the longitudinal direction of the waveguide.

The diffraction and refraction structure preferably forms a two-dimensional Fresnel lens.

The waveguide is preferably an SOI ridge waveguide having a ridge which is formed in a wave-guiding silicon layer of an SOI material on a silicon dioxide layer and the longitudinal direction of which extends along the direction of propagation of the radiation guided in the SOI ridge waveguide.

With regard to an optimum coupling efficiency, it is considered to be particularly advantageous if the diffraction and refraction structure is two-dimensional and is in a plane parallel to the wave-guiding silicon layer, the diffraction and refraction structure being location-dependent in two dimensions, specifically in a dimension dependent on the location along the longitudinal direction of the ridge of the SOI waveguide and in a dimension perpendicular thereto dependent on the location perpendicular to the longitudinal direction of the ridge of the SOI waveguide.

Webs are preferably situated beside the ridge, the layer height of which webs is lower than that of the ridge.

An alternative, but likewise preferred, configuration provides for at least sections of the wave-guiding silicon layer to have been removed beside the ridge.

The invention also relates to an optical element which has a photonically integrated chip.

Such an element preferably comprises a fiber, the fiber end of which is coupled to the optical diffraction and refraction structure on that side of the latter which faces away from the grating coupler, the longitudinal direction of the fiber being oriented virtually perpendicularly to the wave-guiding layer(s) of the chip in the region of the fiber end. In this case, the term “virtually perpendicular” is understood as meaning an angular range between 70° and 90°.

Alternatively or additionally, the optical element may comprise a radiation emitter which is coupled to the optical diffraction and refraction structure on that side of the latter which faces away from the grating coupler, the radiation direction of the radiation emitter being oriented virtually perpendicularly to the wave-guiding layer(s) of the chip.

Alternatively or additionally, the optical element may comprise a radiation detector which is coupled to the optical diffraction and refraction structure on that side of the latter which faces away from the grating coupler, the active reception surface of the radiation detector being oriented parallel to the wave-guiding layer(s) of the chip.

The invention also relates to a method for producing a photonically integrated chip which comprises a substrate and a plurality of material layers applied to a top side of the substrate, wherein, in the method, an optical waveguide is integrated in one or more wave-guiding material layers of the chip, and a grating coupler is formed in the optical waveguide and causes beam deflection of radiation guided in the waveguide in the direction out of the layer plane of the wave-guiding material layer(s) or causes beam deflection of radiation to be coupled into the waveguide in the direction into the layer plane of the wave-guiding material layer(s).

With respect to such a method, the invention provides for an optical diffraction and refraction structure to be integrated in a material layer above or below the waveguide or in a plurality of material layers of the chip above or below the waveguide or on the rear side of the substrate, which diffraction and refraction structure carries out beam shaping of the radiation before it is coupled into the grating coupler or after it has been coupled out of the grating coupler.

With respect to the advantages of the method according to the invention, reference is made to the statements above in connection with the chip according to the invention.

It is advantageous if a lens, a beam splitter or a polarization separator is produced as the optical diffraction and refraction structure.

The production of the optical diffraction and refraction structure is preferably carried out by etching steps in one or more material layers of the chip above or below the optical grating coupler or preferably at least also comprises etching of steps.

In order to be able to carry out the etching steps with optimum positioning, one or more lithography steps for applying one or more etching masks are preferably carried out in advance.

Depending on the demand imposed on the coupling efficiency of the diffraction and refraction structure, the number of etching steps and therefore the steps of graduated depth can be kept low, as a result of which the production costs can remain low. Even if only a single etching step is used, it is possible to implement a binary diffraction and refraction structure, also called a phase plate, which, with the same aperture, achieves a slightly lower coupling efficiency, however, than a diffraction and refraction structure having a plurality of steps. If a sufficient aperture on the chip can be achieved, a sufficient coupling efficiency can also be readily achieved, however, with a binary structure.

In order to achieve any desired transformations of the incident wave front, the individual steps of the optical diffraction and refraction structure produced can be made independently of one another in both spatial directions of the plane of the substrate.

Suitably selecting the spatial distribution of the etching steps makes it possible to spatially separate the incident light beam into individual separated partial beams which can be guided further independently of one another. Such separation can also be implemented using different polarization directions of the separated partial beams.

The invention is explained in more detail below using exemplary embodiments; in this case, by way of example,

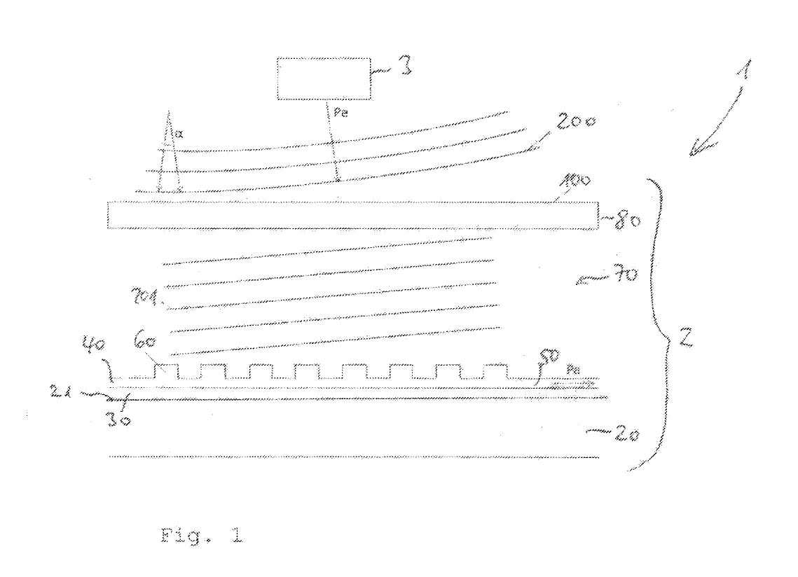

FIG. 1 shows an exemplary embodiment of an optical element which is equipped with a diffraction and refraction structure,

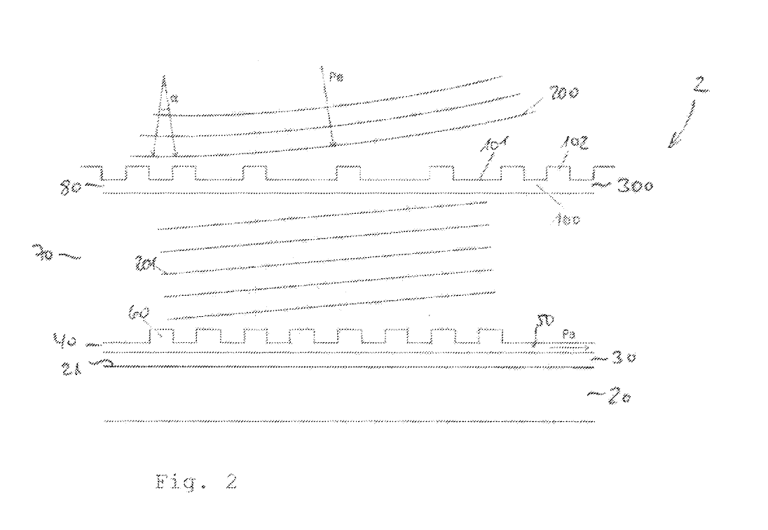

FIG. 2 shows an exemplary embodiment of a photonically integrated chip in which a diffraction and refraction structure forms a Fresnel lens,

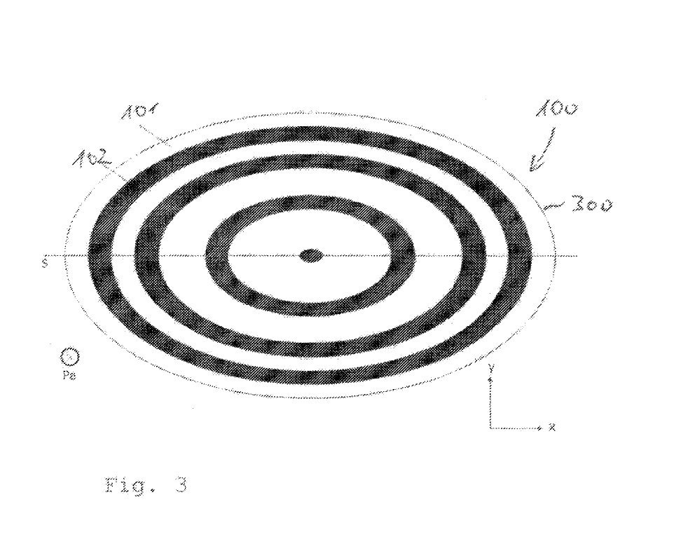

FIG. 3 shows a plan view of the structure of the Fresnel lens according to FIG. 2,

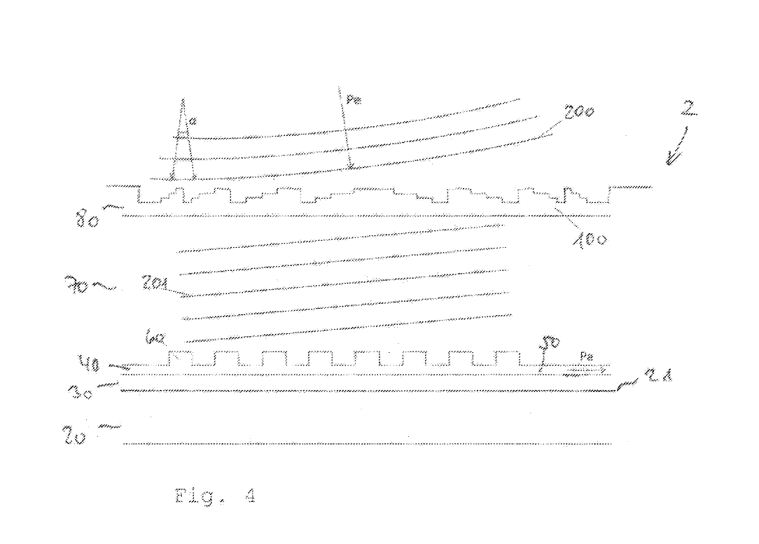

FIG. 4 shows an exemplary embodiment of a photonically integrated chip in which a diffraction and refraction structure has multiple steps,

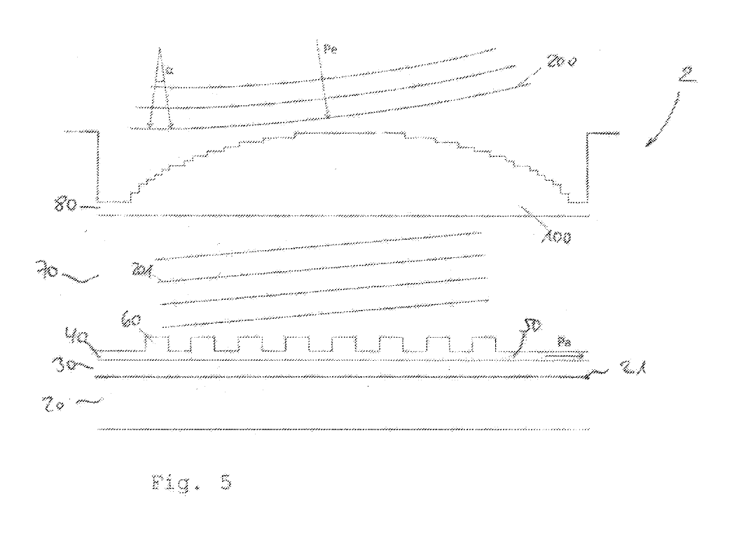

FIG. 5 shows another exemplary embodiment of a photonically integrated chip having a multi-step diffraction and refraction structure,

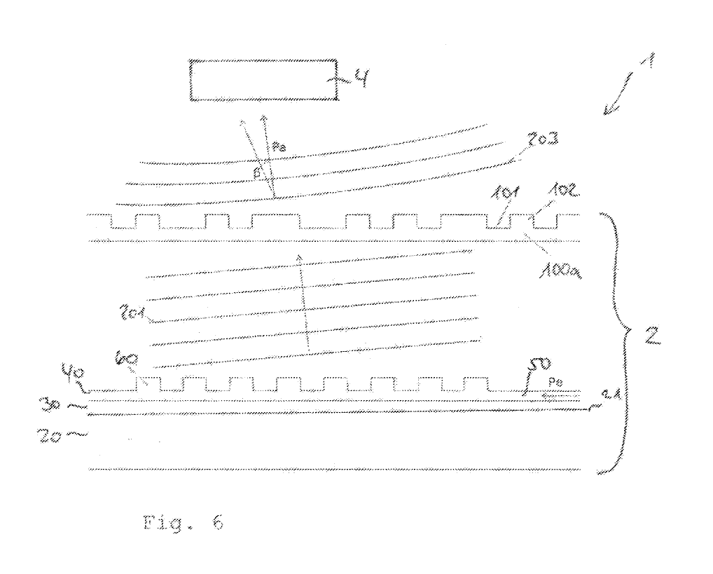

FIG. 6 shows an exemplary embodiment of an optical element in which a diffraction and refraction structure of a photonically integrated chip has a single step and forms a two-dimensional binary stepped lens,

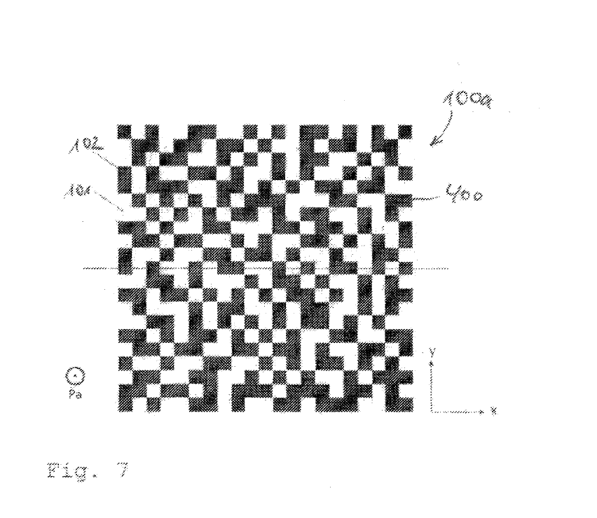

FIG. 7 shows a plan view of the binary stepped lens according to FIG. 6,

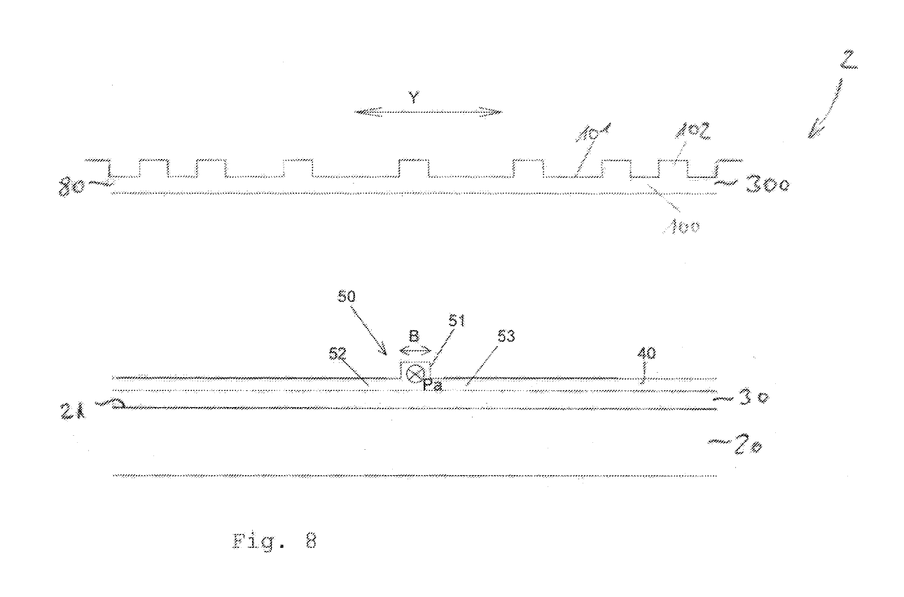

FIG. 8 shows an exemplary embodiment of an SOI waveguide which is suitable for the optical elements according to FIGS. 1 and 6 and the photonically integrated chips according to FIGS. 2 and 4 to 5, specifically on the basis of the photonically integrated chip according to FIG. 2, for example, and

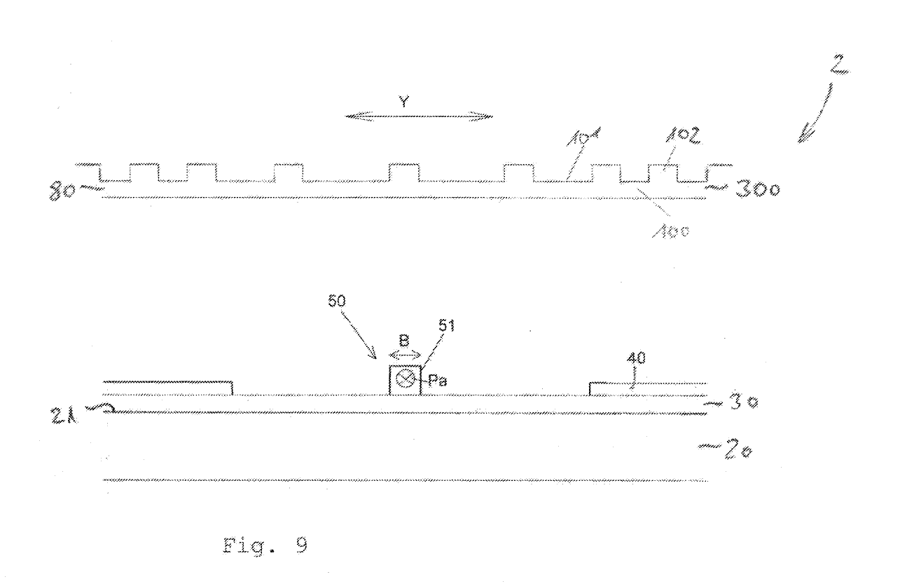

FIG. 9 shows another exemplary embodiment of an SOI waveguide which is suitable for the optical elements according to FIGS. 1 and 6 and the photonically integrated chips according to FIGS. 2 and 4 to 5, specifically on the basis of the photonically integrated chip according to FIG. 2, for example.

For the sake of clarity, the same reference symbols are always used for identical or comparable components in the figures.

FIG. 1 shows an exemplary embodiment of an optical element 1 which comprises a photonically integrated chip 2 or may be formed solely by such a chip. In the exemplary embodiment according to FIG. 1, it is assumed, for example, that the optical element 1 has, in addition to the chip 2, a radiation-emitting component 3, for example in the form of a laser or a radiation emitter.

The photonically integrated chip 2 comprises a substrate 20, on the top side 21 of which a plurality of material layers are arranged. A silicon dioxide layer 30, inter alia, is thus situated on the top side 21 of the substrate 20, on which silicon dioxide layer a wave-guiding silicon layer 40 is in turn arranged. The substrate 20, the silicon dioxide layer 30 and the wave-guiding silicon layer 40 may be formed by a so-called SOI (silicon on insulator) material which is commercially available in prefabricated form.

A ridge waveguide 50 is provided in the wave-guiding silicon layer 40 and can be formed, for example, by etching the wave-guiding silicon layer 40. A grating coupler 60 in the form of a Bragg grating is connected to the ridge waveguide 50 and has preferably likewise been produced by etching the wave-guiding silicon layer 40.

In the exemplary embodiment according to FIG. 1, further material layers, for example in the form of an intermediate layer 70 and an upper covering layer 80, are situated on the wave-guiding silicon layer 40.

A diffraction and refraction structure 100, which is not illustrated in any more detail in FIG. 1, is integrated in the covering layer 80. The diffraction and refraction structure 100 is preferably produced by means of one or more lithography steps and by means of one or more etching steps; exemplary embodiments of this are explained in yet more detail further below.

The optical element 1 according to FIG. 1 can be operated as follows, for example:

The radiation-emitting component 3 produces a divergent light beam Pe, the curved wave front 200 of which has a divergence α. The divergent light beam Pe strikes the diffraction and refraction structure 100 which, in the exemplary embodiment according to FIG. 1, is arranged in the covering layer 80 and therefore in the so-called “backend of line” region of the photonically integrated chip 2.

The diffraction and refraction structure 100 transforms the incident wave front 200 of the divergent light beam Pe into a planar wave front 201 which then strikes the grating coupler 60 and is coupled into the ridge waveguide 50 via said coupler. The light guided in the ridge waveguide 50 is identified using the reference symbol Pa in FIG. 1.

In summary, the diffraction and refraction structure 100 in the exemplary embodiment according to FIG. 1 is used to carry out beam shaping and to transform the curved wave front 200 into a planar wave front 201, thus improving the efficiency when coupling light into the grating coupler 60 or into the ridge waveguide 50.

FIG. 2 shows an exemplary embodiment of a diffraction and refraction structure 100, which can be used in the photonically integrated chip 2 of the element 1 according to FIG. 1, in more detail. It can be seen that the diffraction and refraction structure 100 in the exemplary embodiment according to FIG. 2 is formed by a single-step stepped profile which comprises etched sections 101 and unetched sections 102. The arrangement of the etched sections 101 and unetched sections 102 is selected in such a manner that the diffraction and refraction structure 100 forms a Fresnel lens 300.

The Fresnel lens 300 formed by the etched sections 101 and unetched sections 102 of the diffraction and refraction structure 100 is shown in more detail in a plan view in FIG. 3.

FIG. 4 shows another exemplary embodiment of a diffraction and refraction structure 100 which can be used in the photonically integrated chip 2 of the optical element 1 according to FIG. 1. The diffraction and refraction structure 100 is formed by a three-step stepped profile which has been formed in the upper or uppermost covering layer 80 of the chip 2 by means of lithography and etching steps. The step height and step arrangement of the steps is selected in such a manner that the beam shaping of the divergent light beam Pe is possibly favorable with regard to a wave front 201 which is as planar as possible and with regard to an optimum coupling efficiency with respect to the grating coupler 60 and the ridge waveguide 50.

FIG. 5 shows another exemplary embodiment of a diffraction and refraction structure 100 which can be used in the photonically integrated chip 2 of the optical element 1 according to FIG. 1.

In the exemplary embodiment according to FIG. 5, a multi-step lens profile has been produced in the upper covering layer 80 of the photonically integrated chip 2 by means of a multiplicity of lithography and etching steps, which lens profile may comprise thirteen steps, for example. The stepped profile or the outer shape of the lens is selected in such a manner that the coupling efficiency is possibly optimal in the direction of the grating coupler 60 and in the direction of the ridge waveguide 50.

FIG. 6 shows another exemplary embodiment of an optical element 1 which is equipped with a photonically integrated chip 2. In addition to the photonically integrated chip 2, the optical element 1 comprises a radiation-receiving component 4 which may be a radiation detector, for example.

The photonically integrated chip 2 has a substrate 20, a buried silicon dioxide layer 30, a wave-guiding silicon layer 40, an intermediate layer 70 and an upper covering layer 80 in which a diffraction and refraction structure 100a is provided. A ridge waveguide 50 and a grating coupler 60 are integrated in the wave-guiding silicon layer 40, preferably by means of etching.

The diffraction and refraction structure 100a in the covering layer 80 is formed by a single-step stepped profile or a binary step filter which comprises etched sections 101 and unetched sections 102.

The optical element 1 according to FIG. 6 can be operated as follows, for example:

A light beam Pe which is guided in the ridge waveguide 50 reaches the grating coupler 60 which couples out the light beam Pe and deflects it in the direction of the radiation-receiving component 4. The deflected beam preferably has a planar wave front 201.

The planar wave front 201 reaches the diffraction and refraction structure 100a which carries out beam shaping and converts the previously planar wave front 201 into a convergent wave front 203 with a divergence β. The resulting convergent light beam is identified using the reference symbol Pa in FIG. 6.

An exemplary embodiment of a diffraction and refraction structure 100a which can be used in the photonically integrated chip 2 according to FIG. 6 is illustrated in more detail, for example, in FIG. 7. FIG. 7 shows a diffraction and refraction structure 100a which can be produced using only one etching step and has etched sections 101 and unetched sections 102. The diffraction and refraction structure 100a forms a binary stepped lens 400.

FIG. 8 shows a cross section of an exemplary embodiment of an SOI waveguide in the form of an SOI ridge waveguide which is suitable for the optical elements according to FIGS. 1 and 6 and the photonically integrated chips according to FIGS. 2 and 4 to 5, specifically on the basis of the photonically integrated chip according to FIG. 2, for example.

The substrate 20, on the top side 21 of which a plurality of material layers are arranged, is seen in FIG. 8. The silicon dioxide layer 30, inter alia, is situated on the top side 21 of the substrate 20, on which silicon dioxide layer the wave-guiding silicon layer 40 is in turn arranged. The substrate 20, the silicon dioxide layer 30 and the wave-guiding silicon layer 40 are formed by an SOI (silicon on insulator) material.

A ridge waveguide 50 is provided in the wave-guiding silicon layer 40; the ridge width of the ridge 51 is identified using the reference symbol B in FIG. 8. Webs 52 and 53 are situated beside the ridge 51 and their web height or layer height is lower than that of the ridge 51. The direction of propagation of the light beam Pa according to FIG. 2 is perpendicular to the image plane in FIG. 8 and may be directed out of the image plane or into the image plane; in the exemplary embodiment according to FIG. 8, it is assumed, for example, that the light beam Pa is directed into the image plane.

Further material layers, for example in the form of the intermediate layer 70 and the upper covering layer 80, are situated on the wave-guiding silicon layer 40.

The diffraction and refraction structure 100 is integrated in the covering layer 80, is two-dimensional and carries out beam shaping in two axes, namely both along the arrow direction or along the direction of propagation of the light beam Pa according to FIGS. 2 and 8—that is to say along the longitudinal direction of the ridge waveguide 50—and perpendicular thereto, that is to say along the arrow direction Y in FIG. 8. As already mentioned, the diffraction and refraction structure 100 is preferably produced by means of one or more lithography steps and by means of one or more etching steps.

FIG. 8 also reveals that the diffraction and refraction structure 100 is formed, along the arrow direction Y, by a single-step stepped profile which comprises etched sections 101 and unetched sections 102.

The arrangement of the etched sections 101 and unetched sections 102 is selected, for example, in such a manner that the diffraction and refraction structure 100 forms a two-dimensional Fresnel lens 300 or a Fresnel lens 300 which operates in two axes. The Fresnel lens 300 formed by the etched sections 101 and unetched sections 102 of the diffraction and refraction structure 100 is shown in more detail in a plan view in FIG. 3.

It goes without saying that the diffraction and refraction structure 100 may also have multiple steps along the arrow direction Y, as has been explained in connection with FIGS. 4 and 5.

FIG. 9 shows a cross section of another exemplary embodiment of an SOI waveguide which is suitable for the optical elements according to FIGS. 1 and 6 and the photonically integrated chips according to FIGS. 2 and 4 to 5, specifically on the basis of the photonically integrated chip according to FIG. 2, for example.

The substrate 20, on the top side 21 of which a plurality of material layers are arranged, is seen in FIG. 9. The silicon dioxide layer 30, inter alia, is situated on the top side 21 of the substrate 20, on which silicon dioxide layer the wave-guiding silicon layer 40 is in turn arranged. The substrate 20, the silicon dioxide layer 30 and the wave-guiding silicon layer 40 form SOI (silicon on insulator) material.

A ridge waveguide 50 is provided in the wave-guiding silicon layer 40; the ridge width of the ridge 51 is identified using the reference symbol B in FIG. 9. The silicon has been completely removed in sections, for example has been etched away, beside the ridge 51, with the result that the webs 52 and 53 shown in FIG. 8 are missing. For the rest, the explanations above, in particular those in connection with FIG. 8, accordingly apply to the exemplary embodiment according to FIG. 9.

In summary, in the above exemplary embodiments, a lithographically produced optical diffraction and refraction structure 100 is introduced onto one or more upper material layers, preferably onto the uppermost material layer (covering layer 80), of the photonically integrated chip 2, that is to say the so-called “backend of line” region of the photonically integrated chip, for the purpose of subjecting light to beam shaping. For this purpose, step-like structures are preferably etched into the uppermost material layer or one or more upper material layers. Depending on the number of etching steps used, which may be limited by the number of available exposure masks for example, structures having one or more steps of graduated depth can be achieved. These structures function, as a whole, as a refractive and diffractive beam shaping element for a particular wavelength range by spatially varying the refractive index in a targeted manner. The etched and unetched regions have different refractive indices. The times of flight and directions of propagation of light waves through these different regions are therefore different, with the result that the wave front of the incident light wave is deformed after propagation through the diffraction and refraction structure. This effect can be used, for example, to collimate or even focus the light beam before it strikes the grating coupler 60 in the wave-guiding material layer in a deeper layer of the chip 2, the so-called “frontend of line” region of the chip. With a greater number of steps in the diffraction and refraction structure 100, the diffraction and refraction behavior of a perfect lens can be approximated. The diffraction and refraction structure 100 is preferably produced by means of a photolithographic exposure and etching process, which can also be combined with a plasma etching process, or else by means of ion beam etching. This process usually takes place at the end of the complete processing of the chip.

Although the invention was described and illustrated more specifically in detail by means of preferred exemplary embodiments, the invention is not restricted by the disclosed examples and other variations can be derived therefrom by a person skilled in the art without departing from the scope of protection of the invention.

### LITERATURE

[1] Krishnamurthy, R., http://www.chipworks.com/en/technical-competitive-analysis/resources/blog/the-luxtera-cmos-integrated-photonic-chip-in-a-molex-cable/[2]
[2] Mack, Michael; Peterson, Mark; Gloeckner, Steffen; Narasimha, Adithyaram; Koumans, Roger; Dobbelaere, Peter de, Method And System For A Light Source Assembly Supporting Direct Coupling To An Integrated Circuit, U.S. Pat. No. 8,772,704 B2, filed by Luxtera on May 14, 2013. application Ser. No. 13/894,052. Publication no.: U.S. Pat. No. 8,772,704 B2
[3] Anderson, Jon; Hiramoto, Kiyo, Oclaro, PSM4 Technology & Relative Cost Analysis Update. IEEE 802.3bm Task Force, Phoenix, Jan. 22-23, 2013.

### LIST OF REFERENCE SYMBOLS

1 Element
2 Chip
3 Component
4 Component
20 Substrate
21 Top side
30 Silicon dioxide layer
40 Silicon layer
50 Ridge waveguide
51 Ridge
52 Web
53 Web
60 Grating coupler
70 Intermediate layer
80 Covering layer
100 Diffraction and refraction structure
100a Diffraction and refraction structure
101 Etched sections
102 Unetched sections
200 Curved wave front
201 Planar wave front
203 Convergent wave front
300 Fresnel lens
400 Binary stepped lens
B Ridge width
Pa Light beam
Pe Light beam

1. A photonically integrated chip (2) having
a substrate (20),
a plurality of material layers arranged on a top side (21) of the substrate (20),
an optical waveguide which is integrated in one or more wave-guiding material layers of the chip (2), and
a grating coupler (60) which is formed in the optical waveguide and causes beam deflection of radiation guided in the waveguide in the direction out of the layer plane of the wave-guiding material layer(s) or causes beam deflection of radiation to be coupled into the waveguide in the direction into the layer plane of the wave-guiding material layer(s),
characterized in that
an optical diffraction and refraction structure (100, 100a) is integrated in a material layer of the chip (2) above or below the optical grating coupler (60) or in a plurality of material layers above or below the optical grating coupler (60) or on the rear side of the substrate (20) and carries out beam shaping of the radiation before it is coupled into the waveguide or after it has been coupled out of the waveguide.

2. The photonically integrated chip (2) as claimed in claim 1,
characterized in that
the optical diffraction and refraction structure (100, 100a) forms a lens, a beam splitter or a polarization separator.

3. The photonically integrated chip (2) as claimed in claim 1,
characterized in that
the optical diffraction and refraction structure (100, 100a) is formed by steps in one or more material layers of the chip (2) above or below the optical grating coupler (60) or at least also comprises such steps.

4. The photonically integrated chip (2) as claimed in claim 1,
characterized in that
the waveguide is a ridge waveguide (50) which comprises a ridge formed in a wave-guiding material layer of the chip (2), and
the optical diffraction and refraction structure (100, 100a) is integrated in one or more layers of the chip (2) above or below the ridge.

5. The photonically integrated chip (2) as claimed in claim 4,
characterized in that
the ridge waveguide (50) is formed in a silicon covering layer of an SOT material, and
the optical diffraction and refraction structure (100, 100a) is integrated in one or more layers of the chip (2) above the silicon covering layer.

6. The photonically integrated chip (2) as claimed in claim 1,
characterized in that
the diffraction and refraction structure (100) is two-dimensional and is in a plane parallel to the wave-guiding material layer(s) (40), and
the diffraction and refraction structure (100) is location-dependent in two dimensions, specifically dependent on the location in a dimension along the longitudinal direction of the waveguide and dependent on the location in a dimension perpendicular thereto, i.e. in a dimension perpendicular to the longitudinal direction of the waveguide.

7. The photonically integrated chip (2) as claimed in claim 1,
characterized in that
the diffraction and refraction structure (100) forms a two-dimensional Fresnel lens.

8. The photonically integrated chip (2) as claimed in claim 1,
characterized in that
the waveguide is an SOT ridge waveguide (50) having a ridge (51) which is formed in a wave-guiding silicon layer (40) of an SOT material on a silicon dioxide layer (30) and the longitudinal direction of which extends along the direction of propagation of the radiation guided in the SOT ridge waveguide, and
the diffraction and refraction structure (100) is two-dimensional and is in a plane parallel to the wave-guiding silicon layer (40), the diffraction and refraction structure (100) being location-dependent in two dimensions, specifically dependent on the location in a dimension along the longitudinal direction of the ridge of the SOI waveguide and dependent on the location in a dimension perpendicular thereto, i.e in a dimension perpendicular to the longitudinal direction of the ridge of the SOI waveguide.

9. The photonically integrated chip (2) as claimed in claim 8,
characterized in that
webs (52, 53) are situated beside the ridge (51), the layer height of which webs is lower than that of the ridge (51).

10. The photonically integrated chip (2) as claimed in claim 8,
characterized in that
at least sections of the wave-guiding silicon layer (40) have been removed beside the ridge (51).

11. The photonically integrated chip (2) as claimed in claim 1,
characterized in that
the grating coupler (60) is a one-dimensional or two-dimensional grating coupler (60).

12. An element (1) having a photonically integrated chip (2) as claimed in claim 1.

13. The element (1) as claimed in claim 12,
characterized in that
the optical element (1) comprises a fiber, the fiber end of which is coupled to the optical diffraction and refraction structure (100, 100a) on that side of the latter which faces away from the grating coupler (60),
the longitudinal direction of the fiber being oriented virtually perpendicularly to the wave-guiding layer(s) of the chip (2) in the region of the fiber end.

14. The element (1) as claimed in claim 12,
characterized in that
the optical element (1) comprises a radiation emitter which is coupled to the optical diffraction and refraction structure (100, 100a) on that side of the latter which faces away from the grating coupler (60),
the radiation direction of the radiation emitter being oriented virtually perpendicularly to the wave-guiding layer(s) of the chip (2).

15. The element (1) as claimed in claim 12,
characterized in that
the optical element (1) comprises a radiation detector which is coupled to the optical diffraction and refraction structure (100, 100a) on that side of the latter which faces away from the grating coupler (60),
the active reception surface of the radiation detector being oriented parallel to the wave-guiding layer(s) of the chip (2).

16. A method for producing a photonically integrated chip (2) which comprises a substrate (20) and a plurality of material layers applied to a top side (21) of the substrate (20), wherein, in the method,
an optical waveguide is integrated in one or more wave-guiding material layers of the chip (2), and
a grating coupler (60) is formed in the optical waveguide and causes beam deflection of radiation guided in the waveguide in the direction out of the layer plane of the wave-guiding material layer(s) or causes beam deflection of radiation to be coupled into the waveguide in the direction into the layer plane of the wave-guiding material layer(s),
characterized in that
an optical diffraction and refraction structure (100, 100a) is integrated in a material layer above or below the waveguide or in a plurality of material layers of the chip (2) above or below the waveguide or on the rear side of the substrate (20) and carries out beam shaping of the radiation before it is coupled into the grating coupler (60) or after it has been coupled out of the grating coupler (60).

17. The method as claimed in claim 16,
characterized in that
a lens, a beam splitter or a polarization separator is produced as the optical diffraction and refraction structure (100, 100a).

18. The method as claimed in claim 16,
characterized in that
the production of the optical diffraction and refraction structure (100, 100a) also at least comprises at least one lithography step and at least one etching step for etching steps in one or more material layers of the chip (2) above or below the optical grating coupler (60).
